(19) United States
(12) Patent Application Publication
(10) Pub. No.: US 2004/0208583 A1
(43) Pub. Date: Oct. 21, 2004

(54) Single sideband dense wavelength division multiplexed optical transmission scheme

(76) Inventors: Kameran Azadet, Morganville, NJ (US); Fadi Ryad Olivier Saibi, Red Bank, NJ (US)

Correspondence Address: Ryan, Mason & Lewis, LLP, 1300 Post Road, Suite 205, Fairfield, CT, 06430, US

(21) Appl. No.: 10/229,623

(22) Filed: Aug. 28, 2002

Related U.S. Application Data
(60) Provisional application No. 60/387,828, filed on Jun. 10, 2002.

(51) Int. Cl. H04J 14/02; H04B 10/06

(52) U.S. Cl. 398/85

(57) ABSTRACT

A single-sideband dense wavelength division multiplexing optical communication system and method are disclosed that achieve an increased throughput by moving the carrier wavelengths from the center of the corresponding channel band and suppressing one of the sidebands associated with each channel band. Most of the power is placed in the selected sideband and additional bandwidth is available to increase the throughput within the selected sideband. An electrical signal is modulated to provide a passband signal without low frequency components. The disclosed modulation scheme shifts the carrier wavelengths within the wavelength grid to provide additional bandwidth for the selected sideband in each channel band. Generally, the bandwidth (and thus, throughput) that is available to the selected sideband increases by a factor of two.

### CROSS REFERENCE TO RELATED APPLICATIONS

This application claims the benefit of U.S. Provisional Application No. 60/387,828, filed Jun. 10, 2002.

### FIELD OF THE INVENTION

The present invention relates generally to wavelength division multiplexing transmission schemes, and more particularly, to a dense wavelength division multiplexing (DWDM) single sideband (SSB) transmission scheme based on a novel optical multiplexing scheme.

### BACKGROUND OF THE INVENTION

The explosive growth of digital communications technology has resulted in an ever-increasing demand for bandwidth for communicating digital information, such as data, audio and/or video information. To keep pace with the increasing bandwidth demands, new or improved network components and technologies must constantly be developed to perform effectively at the ever-increasing data rates. In optical communication systems, however, the cost of deploying improved optical components becomes prohibitively expensive at such higher data rates. For example, it is estimated that the cost of deploying a 40 Gbps optical communication system would exceed the cost of existing 10 Gbps optical communication systems by a factor of ten. Meanwhile, the achievable throughput increases only by a factor of four.

Thus, much of the research in the area of optical communications has attempted to obtain higher throughput from existing optical technologies. A number of techniques have been proposed or suggested to increase spectral efficiency. For example, a number of techniques have been proposed or suggested to employ multi-carrier transmission techniques over fiber channels. Conventional multi-carrier transmission techniques, however, such as dense wavelength division multiplexing techniques, space the multiple optical carriers and employ band-limited filters so that the multiple carriers do not interfere with one another. The required carrier spacing, however, leads to poor spectral efficiency and thus limits the throughput that can be achieved within the available frequencies. A need therefore exists for a multi-carrier transmission technique that provides improved spectral efficiency. Among other benefits, improved spectral efficiency will allow greater tolerance to dispersion and the use of generic and available optical technologies.

### SUMMARY OF THE INVENTION

Generally, a single-sideband dense wavelength division multiplexing optical communication system and method are disclosed that achieve an increased throughput by moving the carrier wavelength from the center of the corresponding channel band and suppressing one of the sidebands. The sideband can be suppressed, for example, using existing optical filters in the DWDM multiplexer/demultiplexers. In this manner, most of the power is placed in the selected sideband and additional bandwidth is available to increase the throughput within the selected sideband.

An electrical signal is modulated to provide a passband signal without low frequency components. The modulation format could be, for example, Quadrature Amplitude Modulation (QAM) or the mutiplexing of several QAM signals on different RF carriers. The modulation scheme provides carrier wavelengths near the edge of each channel band. One of the sidebands associated with each channel band is suppressed. In one exemplary embodiment, channels are multiplexed in such a way that the carrier wavelengths are not centered on the ITU grid but maintain the ITU grid spacing and one sideband gets rejected, for example, by the existing optical filters in the DWDM multiplexer/demultiplexer. Thus, the modulation scheme in accordance with the present invention shifts the carrier wavelengths within the wavelength grid to provide additional bandwidth for the selected sideband in each channel band. Generally, the bandwidth (and thus, throughput) that is available to the selected sideband increases by a factor of two.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary dense wavelength division multiplexing network environment in which the present invention can operate;

FIG. 2 illustrates an exemplary wavelength grid for a DWDM communication system;

FIG. 3 illustrates a typical modulation scheme for generating each of the signals with wavelengths λ0 through λm shown in FIG. 1;

FIG. 4 illustrates a conventional technique for suppressing the spectrum on one side of the corresponding carrier wavelength using a modulator with in-phase and quadrature phase inputs;

FIG. 5 illustrates the modulation of an electrical signal to provide a passband signal without low frequency components in accordance with one aspect of the invention;

FIG. 6 illustrates the optical spectrum corresponding to the electrical spectrum of FIG. 5;

FIG. 7 illustrates a modulation technique in accordance with the present invention that shifts the carrier wavelength, λ₀, from the center of a channel band and suppresses one of the sidebands; and

FIG. 8 illustrates an exemplary wavelength grid for a DWDM communication system in accordance with the present invention.

### DETAILED DESCRIPTION

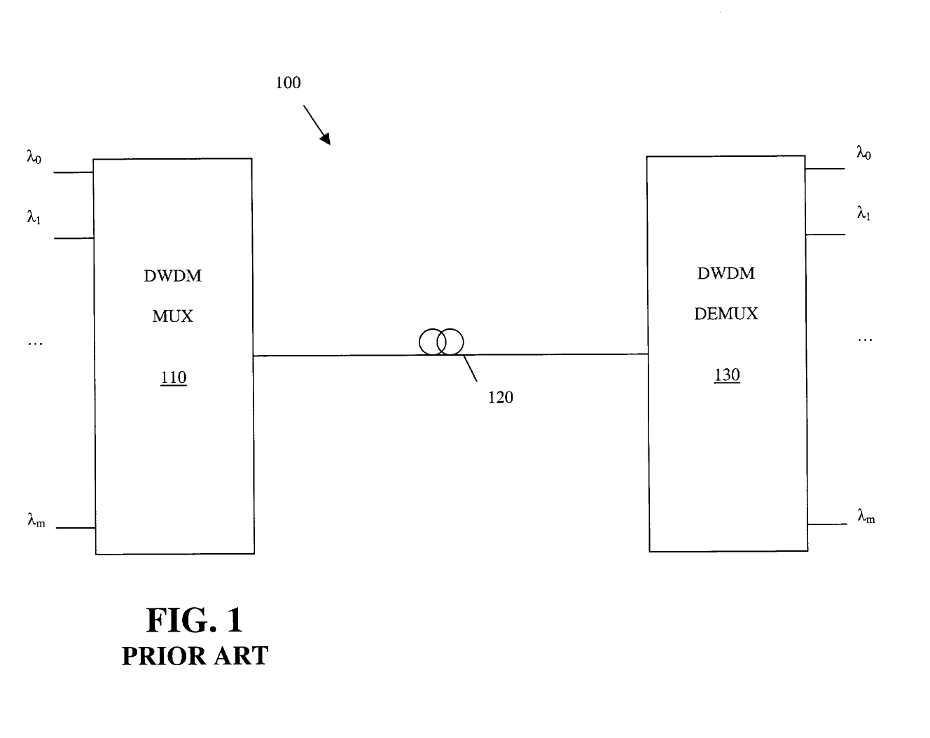

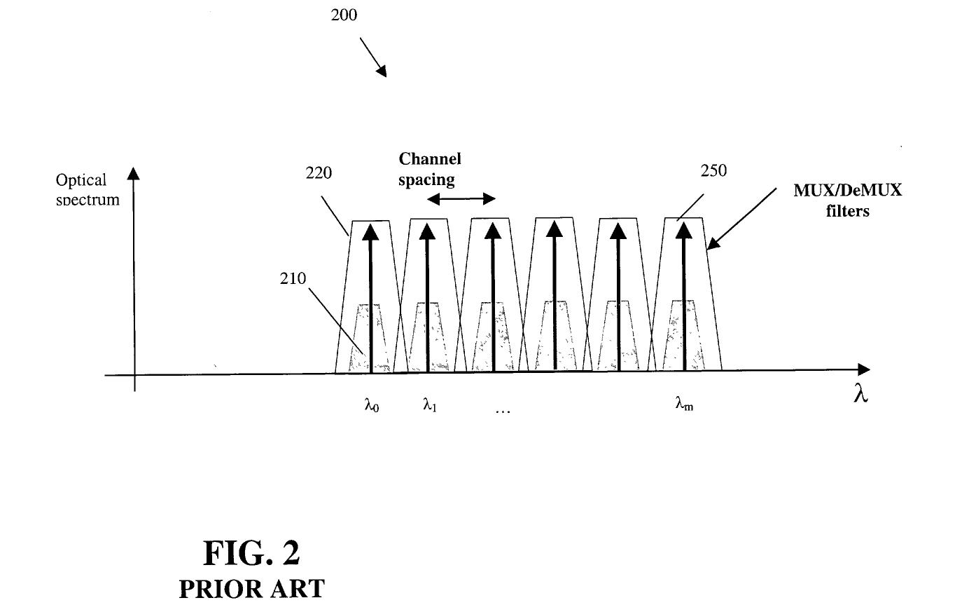

FIG. 1 illustrates an exemplary dense wavelength division multiplexing transmission scheme 100 in which the present invention can operate. As shown in FIG. 1, a plurality of signals having a wavelength λ₀ through λₘ are multiplexed onto an optical fiber 120 using a dense wavelength division multiplexer 110 for transmission to a receiver having a demultiplexer 130. The demultiplexer 130 demultiplexes the received optical signal to recover the multiple signals corresponding to the wavelengths λ₀ through λₘ. The International Telecommunication Union (ITU) has specified a wavelength grid, shown in FIG. 2, for DWDM communication systems with 100 GHz and 50 GHz carrier spacing. The channel bands, such as bands 210, 250, are achieved using filters in the multiplexer 110 and demultiplexer 130. For a more detailed discussion of the specified ITU wavelength grid, see, for example, ITU Recommendation G.692, incorporated by reference herein.

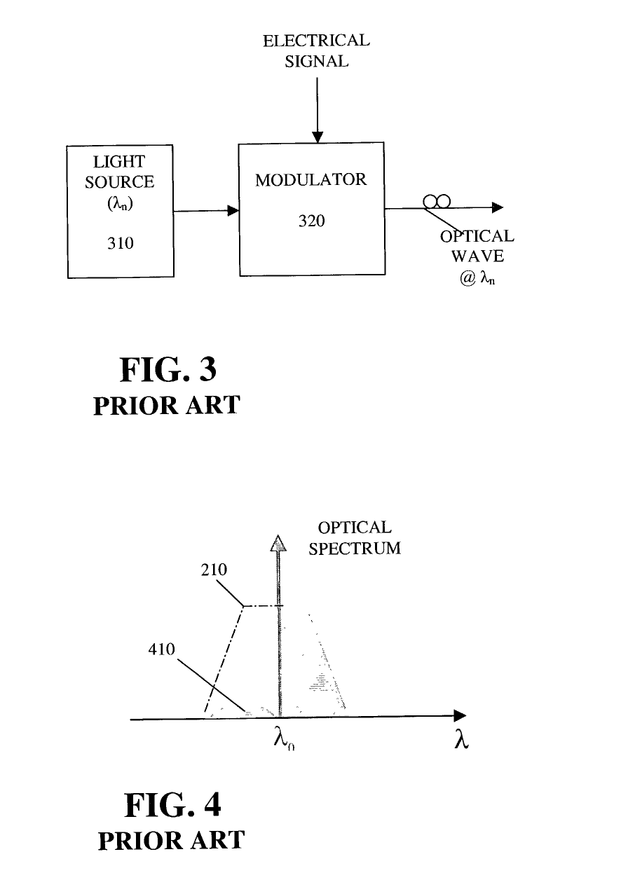

FIG. 3 illustrates a typical modulation scheme for generating each of the signals with wavelengths λ0 through λm. As shown in FIG. 3, a light source 310, such as a laser, having a wavelength λn, generates a light that is modulated by a modulator 320, such as a Mach-Zehnder modulator, to produce an optical wave at the corresponding wavelength λn in accordance with an applied electrical signal. For a more detailed discussion of implementations of the modulation scheme of FIG. 4, see E. Vergnol et al., Interference Lightwave Millmetric Single Side-Band Source: Design and Issues, J. of Light. Tech., Vol. 16, No. 7, 1276-84 (July 1998) or A. Loayssa et al., “Single-Sideband Suppressed-Carrier Modulation Using a Single-Electrode Electrooptic Modulator,” IEEE Photonic Tech. Letters, Vol. 13, No. 8, 869-71 (August 2001), each incorporated by reference herein.

As the amplitude of the optical wave changes between binary values of zero and one, in a non-return to zero (NRZ) implementation, there is a symmetric spectrum 210 around the corresponding carrier wavelength, as shown in FIG. 2. Thus, the bandwidth of the band-limited filters imposes a practical limit on any potential increases of the bit rate or throughput. The bit rate may not be increased to a point that the symmetric spectrum 210 around a carrier wavelength spills over to an adjacent sideband.

A number of techniques have recognized that there is redundant information content on either side of the carrier wavelength. For example, FIG. 4 illustrates a conventional technique that suppresses the spectrum 210 on one side of the corresponding carrier wavelength using a modulator with in-phase and quadrature phase inputs. In general, the residual sideband in these schemes does not vanish completely and a vestigial sideband 410 is present. The vestigial sideband 410 can be made arbitrarily small when diminishing the input electrical signal amplitude, as discussed in E. Vergnol et al., referenced above. If the disclosed techniques were generalized to work with broadband signals, it would need the design of a good broadband Hilbert transform filter. In practice, however, the vestigial sideband 410 impacts the performance of the conversion of the optical signal to an electrical signal at the receiver. A need therefore exists for better rejection of the vestigial sideband 410.

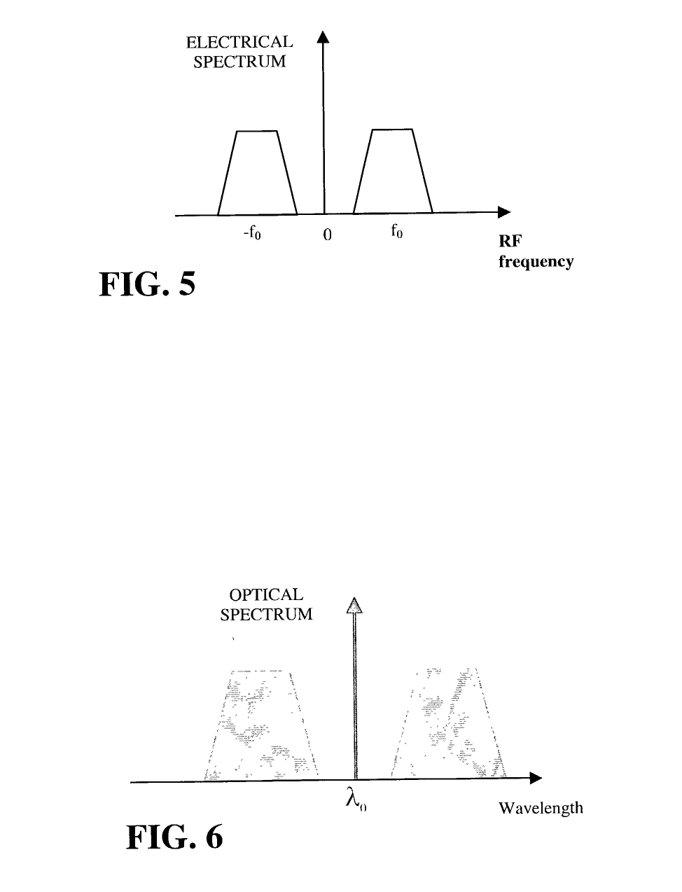

The present invention proposes a new modulation format that provides better rejection of the vestigial sideband 410. As shown in FIG. 5, the present invention initially modulates the electrical signal to provide a passband signal with a center frequency f₀, (and a corresponding image band at −f₀), such that the electrical signal does not contain low frequency components. Generally, the baseband electrical signal is mixed with the appropriate RF tone to obtain the two sidebands centered around f₀ and −f₀, as shown in FIG. 5, to remove the frequency content around 0.

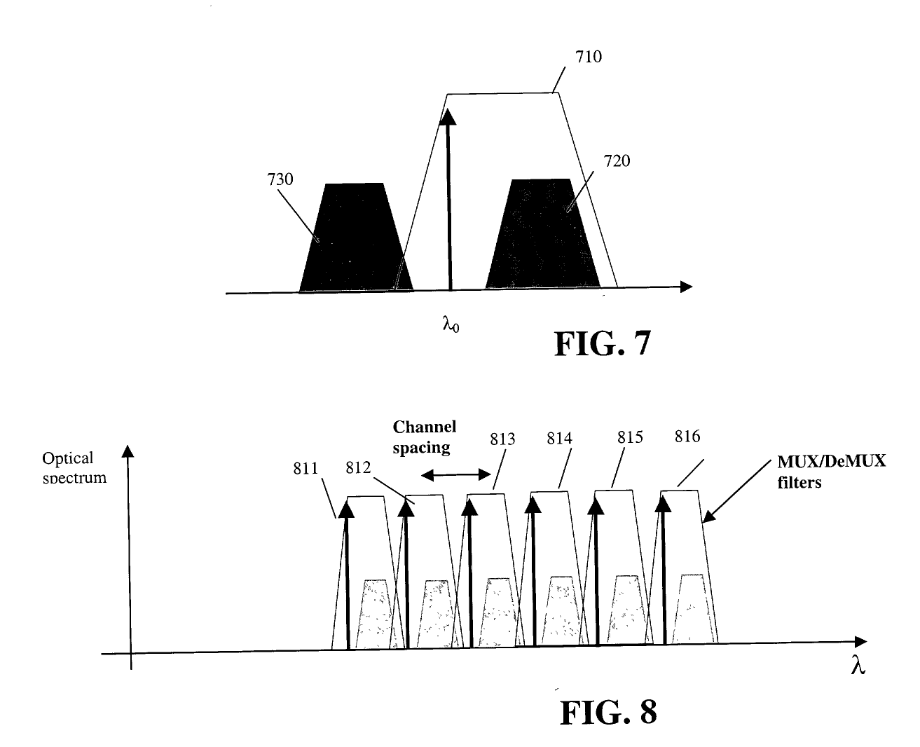

The modulation format could be, for example, Quadrature Amplitude Modulation (QAM) or the mutiplexing of several QAM signals on different RF carriers. The optical spectrum corresponding to the electrical spectrum of FIG. 5 is shown in FIG. 6. As shown in FIG. 6, the optical spectrum does not have spectral power close to the optical carrier wavelength, λ₀. According to one aspect of the invention, shown in FIG. 7, the exemplary dense wavelength division multiplexing transmission scheme 100 achieves an increased throughput within the exemplary ITU wavelength grid (FIG. 2), by shifting the carrier wavelength towards the edge of the channel band and suppressing one of the sidebands. Thus, channels are multiplexed in such a way that the carrier wavelengths are not centered on the ITU grid but still have the ITU grid spacing and one sideband gets rejected, for example, by the existing optical filters in the multiplexer 110 and demultiplexer 130.

As shown in FIG. 7, the carrier wavelength, λ₀, is shifted from the center of the channel band 710 towards the left edge of the channel band 710, and the left sideband 730 is suppressed. In this manner, most of the power is placed in the selected sideband and there is additional bandwidth to increase the throughput within the selected sideband 720. In addition, the small signal constraints associated with conventional techniques (due to an approximation of non-linear relationship between the electrical power and optical field, that is only valid when the electrical signal is small) are not encountered with the present invention.

FIG. 8 illustrates the optical spectrum in accordance with the present invention. As shown in FIG. 8, the channel bands 811-816 maintain the wavelength grid and channel spacing specified by the ITU. Thus, the carrier wavelengths are shifted within the wavelength grid to remove the redundant information contained in one of the sidebands to provide additional bandwidth for the selected sideband in each channel band. Generally, the bandwidth (and thus, throughput) that is available to the selected sideband increases by a factor of two.

In one embodiment, the suppressed sideband, such as the sideband 730, is suppressed using the filters in the multiplexer 110 and demultiplexer 130. The suppressed sidebands will be out of the channel bands 811-816 and are rejected by the corresponding optical filter. Furthermore, this scheme works with broadband signals and does not need an electrical Hilbert transform filter.

In a conventional DWDM system with 50 GHz channel spacing, a 20 Gb/s NRZ signal can be born by each wavelength (within the 40 GHz total bandwidth). Thus, the spectral efficiency is 0.4 b/s/Hz. When the present invention is employed in the same DWDM system with 50 GHz channel spacing, a SSB QAM-4 signal at 40 Gb/s can be attached to each wavelength (within the 40 GHz total bandwidth, to achieve a spectral efficiency of 0.8 b/s/Hz. In addition, to the increased spectral efficiency, the present invention exhibits the benefits from chromatic dispersion immunity in SSB schemes.

It is to be understood that the embodiments and variations shown and described herein are merely illustrative of the principles of this invention and that various modifications may be implemented by those skilled in the art without departing from the scope and spirit of the invention.

We claim:

1. A method for transmitting an optical signal over a wavelength division multiplexed channel, said method comprising the steps of:
obtaining a passband electrical signal by modulating an incoming electrical signal;
applying said passband electrical signal to a light source having a given wavelength to obtain an optical signal; and
suppressing one of said associated sidebands using an optical filter.

2. The method of claim 1, wherein said optical filter is part of a DWDM multiplexer.

3. A method for transmitting an optical signal over a wavelength division multiplexed channel, said method comprising the step of:
modulating said optical signal onto a carrier wavelength within said wavelength division multiplexed channel, said carrier wavelength having two associated sidebands and a wavelength away from a center of said wavelength division multiplexed channel, such that one of said associated sidebands are suppressed.

4. The method of claim 3, wherein said suppression is performed by a DWDM multiplexer.

5. The method of claim 3, wherein said suppression is performed by an optical filter.

6. The method of claim 3, wherein said wavelength division multiplexed channel conforms to a wavelength grid specified by the ITU.

7. The method of claim 3, wherein said wavelength division multiplexed channel has a channel spacing with an adjacent wavelength division multiplexed channel that conforms to a specification of the ITU.

8. The method of claim 3, wherein said wavelength division multiplexed channel has a channel band that conforms to a specification of the ITU.

9. The method of claim 3, wherein said wavelength is near an edge of said wavelength division multiplexed channel.

10. The method of claim 3, wherein said modulating step minimizes any low frequency components in said optical signal.

11. A system for transmitting an optical signal over a wavelength division multiplexed channel, said system comprising:
a modulator for modulating said optical signal onto a carrier wavelength within said wavelength division multiplexed channel, said carrier wavelength having two associated sidebands and a wavelength away from a center of said wavelength division multiplexed channel, such that one of said associated sidebands are suppressed.

12. The system of claim 11, wherein said suppression is performed by an optical filter.

13. The system of claim 11, wherein said wavelength division multiplexed channel conforms to a wavelength grid specified by the ITU.

14. The system of claim 11, wherein said wavelength is near an edge of said wavelength division multiplexed channel.

15. The system of claim 11, wherein said modulator minimizes any low frequency components in said optical signal.

16. A dense wavelength division multiplexed receiver, comprising:
a demultiplexer conforming to a wavelength grid having a plurality of wavelength division multiplexed channels, each of said channels having a carrier wavelength and two associated sidebands, wherein at least one of said carrier wavelengths is removed from a center of said corresponding channel.

17. The receiver of claim 16, wherein said wavelength grid conforms to a wavelength grid specified by the ITU.

18. The receiver of claim 16, wherein said carrier wavelength is near an edge of said wavelength division multiplexed channel.
